(19) United States
(12) Patent Application Publication
(10) Pub. No.: US 2002/0155202 A1
(43) Pub. Date: Oct. 24, 2002

(54) Container assembly

(76) Inventor: John P. Rebhorn, Maple Grove, MN (US)

Correspondence Address: GENERAL MILLS, INC., P.O. BOX 1113, MINNEAPOLIS, MN, 55440, US

(21) Appl. No.: 10/074,107

(22) Filed: Feb. 12, 2002

Related U.S. Application Data
(63) Continuation-in-part of application No. 09/781,582, filed on Feb. 12, 2001.

(51) Int. Cl. A23L 1/31

(52) U.S. Cl. 426/281

(57) ABSTRACT

The present invention is directed to a container assembly for delivering food products for on the go consumers. The exemplary container assembly is composed of two containers or vessels having different dimensions and volumes and different sized outlets to permit two products to be dispensed in accordance with proportionally predetermined amounts. The container is provided with nestling capability, which prevents splaying and creates package integrity to provide for a near homogenous product offering that can be easily gripped and consumed by the individual.

### CROSS REFERENCES TO RELATED APPLICATIONS

This application is a continuation-in-part of application Ser. No. 09/781,582 filed Feb. 12, 2001, the disclosure of which including that found in the claims is incorporated herein by reference.

### THE FIELD OF THE INVENTION

The present invention relates to a container assembly for dispensing consumable products. More particularly, although not exclusively, the present invention relates to a multi container assembly in which different consumable products are contained within different sized containers that are easily grippable, which nestle together and have outlets positioned to enable the contents of each container to be simultaneously delivered to the mouth of the consumer.

### BACKGROUND OF THE INVENTION

Consumable food products, such as ready to eat cereal (“RTE”) and milk, are typically sold in individual containers. In some cases different food products are provided in separate compartments of a common container sealed by a common seal or closure. Exemplary food products, include such things as potato chips and chip dip which may have separate compartments, but which are provided in a single, sealed container. Still further containers of food products may provide rupturable cells or cups in a single container, which require a physical breaking to access the compartments. However, such arrangements may require the products to follow tortuous paths to escape the container, causing such problems as clogging, premature dispensing or mixing or delayed delivery to that of the other product provided in the container.

Interconnnected containers have also been used but they typically consist of identical containers, which are secured to one another. However, this type of container suffers from the defect that the manufacturer is forced into a one size fits all scenario, even if the manufacturer intends to provide varying amounts of different materials. This can create a problem of the receptacle only appearing half full. Other problems with multiple containers, which are secured to one another, are that the containers may not readily separate from one another such that the consumer cannot discard an undesired portion of the container assembly.

Multiple vessel assemblies usually require the contents of the vessels or containers to be physically mixed together by a user before consumption. The mixing may occur in the container, such as in the case of the rupturable cell or cup, or in a receptacle, which is external to the container, such as a bowl or plate. In either instance, this may be awkward and messy and the contents may easily spill or the consumer may be required to provide an additional receptacle to receive the contents of the container prior to mixing. It may also be difficult for a consumer to consume the food products “on the go” as such products require an external receptacle and may need the consumer to use both hands to eat the products. In addition, where plural, similar sized, interconnected containers are used, the size of the containers and their respective openings may cause the consumer to receive too much of one product and not enough of the other product due to differences in product viscosity, density or volume.

Other problems with these structures include having to mix the contents or having the contents combined before the consumer is ready to consume the products. This is particularly prevalent with RTE cereals and milk, where the cereal flakes can become soggy and cling to the interior of the container making the cereal not only unpalatable but also difficult to remove from the container. Other multiple compartment solutions, suffer from the difficulty of delivering equivalent amounts of the contents of the compartments at the same time. For example, with milk and RTE cereals, the consumer may get either a mouthful of milk or cereal at one time as opposed to a mix of the two which is the goal of the manufacturer. In addition, when products or “charges” of products are mixed internally, the products can dissolve, become soggy or suffer other deleterious effects before being consumed and the consumer may not be able to complete the serving immediately upon mixing.

What is therefore needed, is a container assembly in which multiple consumable products may be supplied and delivered in a proportionally predetermined amount and which overcome the foregoing problems in the prior art solutions.

### BRIEF SUMMARY OF THE INVENTION

It is an object of the present invention to provide a readily grippable container assembly for the convenient consumption of a combination of consumable products “on the go” without suffering from the following problems.

It is a further object of the invention to provide a container assembly comprising containers filled with different consumable products and having differing viscosities or densities adapted to simultaneously deliver the products to a user for direct consumption without the need of additional receptacles, and in a manner, which delivers the products in a proportionally predetermined amount.

These objects are to be read disjunctively with the object of at least providing the public with a useful choice.

According to a first aspect of the invention there is provided a container assembly for dispensing consumable products that includes a first generally elongate container that is sized and configured and has a first dimension to receive a first consumable product. The container has an outlet at one end thereof, and the outlet has a first opening area.

A second generally elongate container is sized and configured and has a second dimension different from the first dimension to receive a second consumable product. The second container has an outlet at one end thereof, and the outlet has a second opening area different from said first opening area. The outlets of each of the first and second containers are configured and dimensioned to nestle together when the containers are positioned adjacent one another to form a container assembly outlet of a size that can be accommodated by a human mouth. The first and second containers are placed in a cooperative engagement such that the first and second containers do not splay out of an alignment with one another.

The containers are preferably bound together by a binding element such as a heat shrinkable film, label or band. The outlets may nestle together to form a container assembly outlet suitable for receiving a closure. The closure may include a tear away band or film to enable release or it may be a threaded cap adapted to connectively engage with the threads provided on the container outlets.

The first and second containers preferably include interengaging features on adjacent walls to limit relative movement between the containers when interengaged. The interengaging features may be in the form of protuberances and recesses, which extend generally, longitudinally of each of the containers. The interengaging features hold the containers together but do not lock the containers into a permanent association. In the event that the consumer wishes to separate the two containers, the consumer may do so by removal of the exterior band, label or wrapper. The bottles may be provided with deformable regions to assist in dispensing consumable products within the containers. The deformable regions may be in the form of regions having reduced thickness towards the middle of the containers. Gripping formations may be provided to assist in gripping of the container assembly and in locating the hand of the user to facilitate the deformation of the deformable regions.

The first container is preferably of a larger volume or dimension than the second container. The first container preferably has a passageway through its outlet of larger diameter than a passageway through the outlet of the second container. The passageways in the outlets of the first and second containers may be dimensioned so as to allow products to flow at rates commensurate with the viscosity or density of each product and to deliver products in a proportionally predetermined amount. The outlet of the first container is somewhat crescent shaped so as to accommodate the outlet of the second container, which is substantially circular. The outlets of the container assembly when in operative association with one another is preferably substantially circular and are about 38 mm in diameter. Each container is preferably provided with an enlarged flanged foot for stability.

A reclosable tab or plug may be provided to seal the outlet of the second container. Each outlet may be sealed by a seal member such as a foil liner.

The first consumable product may be a granular or powdered food product, such a cereal, snacks or flakes, and the second consumable product may be a different food product, such as a flowable component or liquid, such as milk, water, syrup or yoghurt.

According to a further aspect of the invention there is provided a container assembly for dispensing consumable products, the container assembly includes a first container being sized and configured to receive a first consumable product. The first container has a longitudinal axis and a transverse axis and has a first volume. A second container is sized and configured to receive a second consumable product. The second container has a longitudinal axis and a transverse axis and has a second volume that is different than the first volume. Each of the first and second containers have an outlet, with the outlets of the first and second containers nestling together. At least one of the first and second containers has a deformable region, which is deformable upon the application of pressure in a direction, which is perpendicular to said longitudinal axis of the container.

There is further provided a container assembly, comprising at least first and second containers in which the first container has an exterior wall, a top and bottom, first and second end edges and first and second side edges and a length and a width. The first container has at least one longitudinally extending recess in the exterior wall. The first container making up a first volume of the container assembly. The second container has an exterior wall, first and second end edges and first and second side edges, and a length and a width. The second container has at least one longitudinally extending protuberance in the exterior wall, and the second container making up a second volume of the container assembly. Each of the first and second containers has an outlet in one of the first and second end edges and the outlets of the first and second containers are in co-operative association with one another. The outlets have passageways therethrough of different dimensions. The volume of the first container is greater than the volume of the second container.

This and other objects of the invention will become clear from an inspection of the detailed description of the invention and from the appended claims.

### BRIEF DESCRIPTION OF THE DRAWINGS

The forgoing, as well as other objects and advantages of this invention, will be more completely understood and appreciated by referring to the following more detailed description of the presently preferred exemplary embodiments of the invention in conjunction with the accompanying drawings, of which:

FIG. 1: shows a perspective view of a container assembly according to a first embodiment

FIG. 2: shows a perspective view of the container assembly of FIG. 1 with its closure removed.

FIG. 3: shows a container assembly as shown in FIGS. 1 and 2 with the first and second containers separated.

FIG. 3A: shows a rear perspective view of the smaller container of the container assembly shown in FIGS. 1 to 3 and illustrating the interengaging protuberances.

FIG. 3B: shows a rear perspective view of the larger container of the container assembly shown in FIGS. 1 to 3 and illustrating the interengaging recesses.

FIG. 4: shows a perspective view of the container assembly of FIGS. 1 to 3 illustrating a cutaway view of the containers to show the granular and flowable components.

FIG. 5: shows a container assembly of FIGS. 1 to 3 with heat shrinkable film surrounding the assembly.

FIG. 6A: shows a side view of a closure according to an alternative embodiment.

FIG. 6B: shows a bottom view of the closure shown in FIG. 6A

### DETAILED DESCRIPTION OF PREFERRED EMBODIMENTS

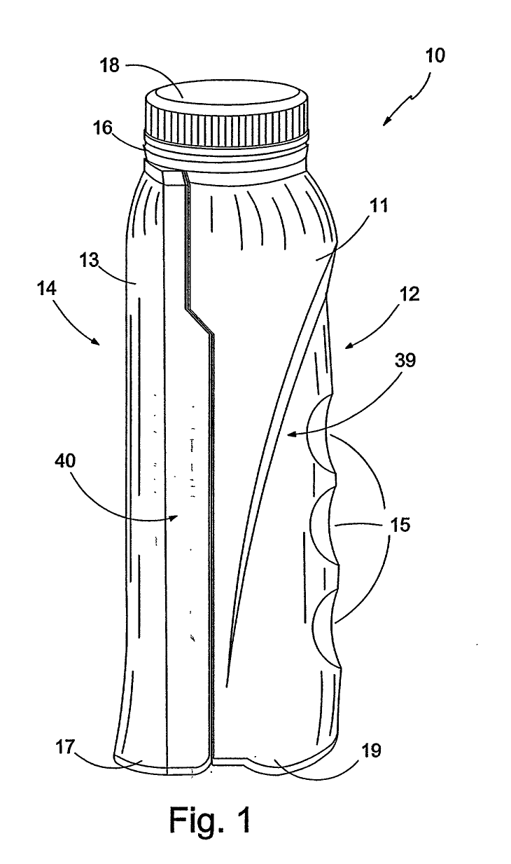

A first embodiment will now be described with reference to FIGS. 1 to 3B. The container assembly 10 includes a first container 12 and a second container 14 retained together by a closure 18. Although the invention will be described in relation to a two container embodiment it is to be appreciated that the inventive concept could be applied to multi part container assemblies consisting of three or more containers where multiple products are to be dispersed.

The first container 12 and the second container 14 may have the same or different internal volumes depending upon the consumable products to be contained therein. In this embodiment container 14 has a smaller volume than container 12. Container 14 has an outlet 20 at one end having a passageway 27 providing a passageway from the interior of the container to the exterior thereof. The outlet 20 is substantially circular to provide ease of flow of the liquid or flowable contents 24. Container 12 has an outlet 22 having a passageway 25 providing a passageway from the interior of the container to the exterior thereof. The outlet 22 has a crescent shape to enable nestling with outlet 20 to complete a substantially circular opening. The periphery of outlet 20 when in operative association with outlet 22 may be positioned near the periphery of outlet 22 or may be positioned slightly below the end edge or periphery of outlet 22. In the latter embodiment, the contents of container 14 will not spill over into the contents of container 12.

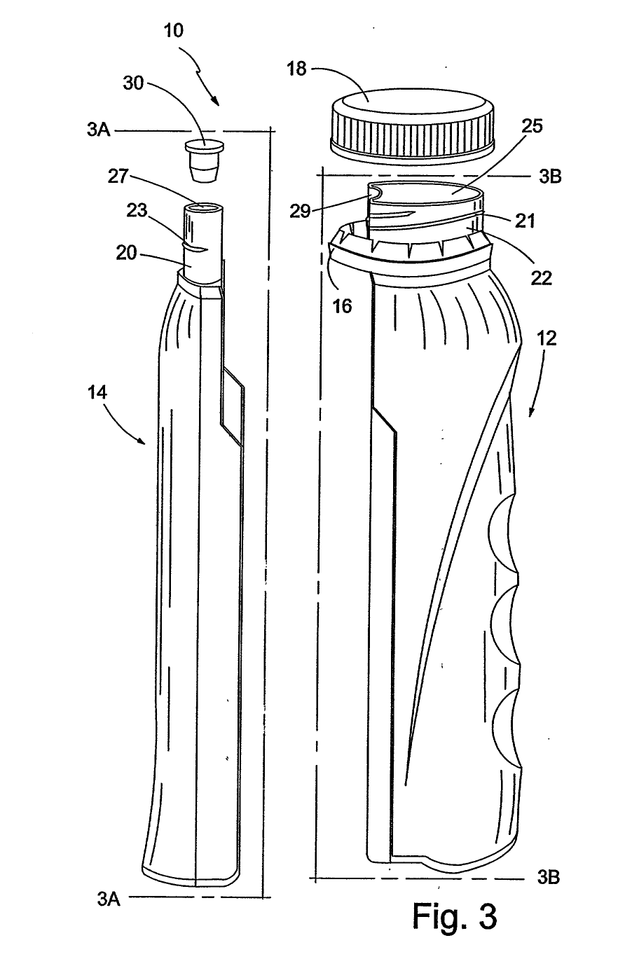

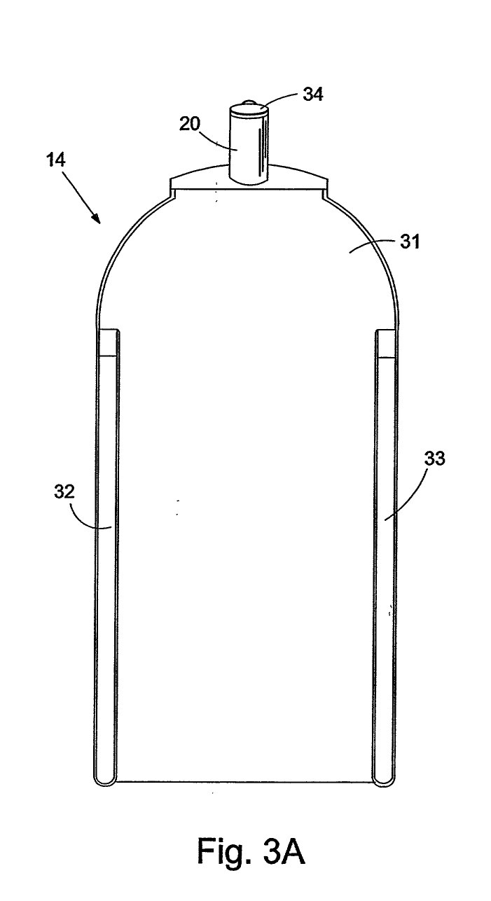

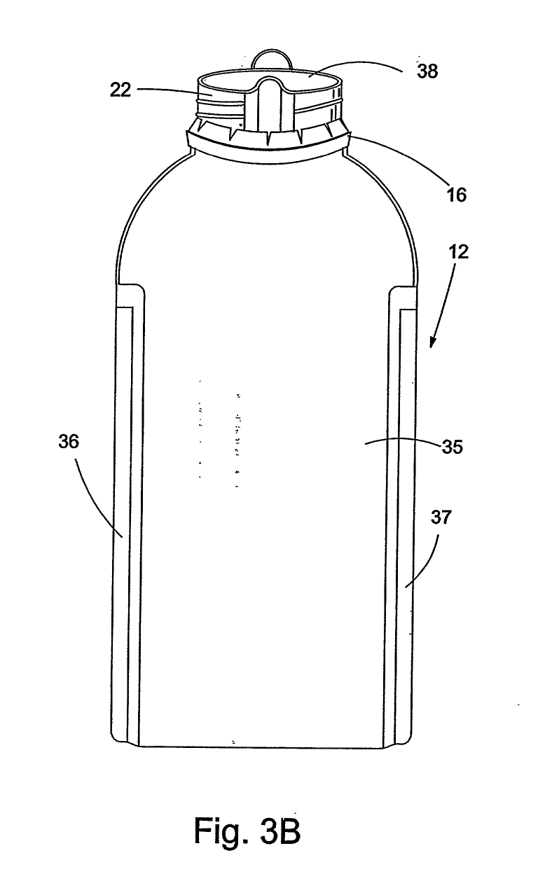

Containers 12 and 14 are configured and dimensioned to interengage to form a container assembly as shown in FIG. 1. Container 12 has an exterior wall including an interior side wall 35 and an outer side wall 11. Container 14 has an exterior wall including an interior side wall 31 and an outer side wall 13. Interior side wall 31 of container 14 and internal side wall 35 of container 12 are provided with interengaging formations (32, 33, 36, 37 FIGS. 3A and 3B) to assist in retaining containers 12 and 14 in a desired assembled relationship. Container 14 has protruberances in the form of ribs 32 and 33 extending outwardly from the peripheral edges of interior side wall 31 and running generally in the longitudinal direction of the container 14. Interior side wall 35 of container 12 includes recesses 36 and 37, complementary to ribs 32 and 33, for interengaging with ribs 32 and 33. Recesses 36, 37 extend inwardly of the exterior wall and run generally in the longitudinal direction of the container 12. Although a pair of interengaging formations are used in this embodiment it will be appreciated that one or more than two formations may be provided on each member. In order to provide stability to the containers 12 and 14 when placed in operative association with one another, the interengaging elements (32, 33, 36 and 37) are at least about 25% of the length of each of the containers 12 and 14 but preferably around 40% of the longitudinal length and more preferably greater than 50 to 60% of the longitudinal length of the containers.

Outlet 22 includes a recessed portion 29 (the crescent shape referred to herein) adapted to accommodate outlet 20 which nestles there within. When containers 12 and 14 are brought into interengagement ribs 32 and 33 locate within recesses 37 and 36 and outlet 20 nestles within recess 29 in outlet 22. Outlets 20 and 22 form a container assembly outlet of substantially cylindrical form having a typical diameter of about 38 mm. The container assembly outlet formed by outlets 20 and 22 is preferably dimensioned such that it may be accommodated by a human mouth. By providing differing sized outlets, 22 and 20, dispensing of the contents 24 and 26 can be accomplished in a predetermined proportionate amount. For example, outlet 22, may dispense a greater volume of product than the amount of product being dispensed from outlet 20. Outlet 22 may dispense from 1.5 to 7 times the total volume of product being dispensed from outlet 20 depending upon the viscosity of the product in container 14. For example, a syrup or yoghurt would flow at a substantially reduced rate when compared to a liquid such as water or milk. Proportionally predetermined dispensing amounts may range from 1 to 1 to 1 to 10, depending on the desired flow rates for the products.

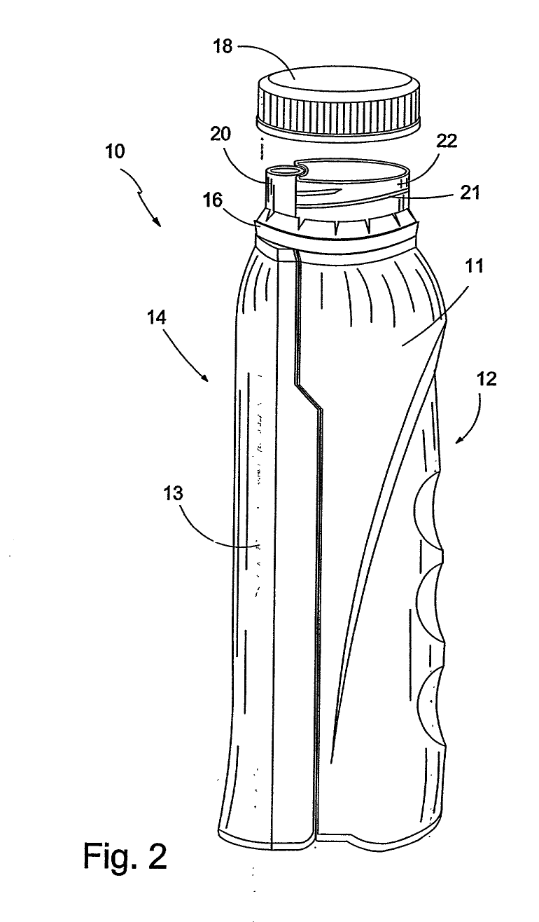

Outlet 20 has a threaded portion or threads 23 provided thereon and outlet 22 has a threaded portion 21 provided thereon. Each of the threaded portions 23 and 21 are provided in an area of the circumference of less than the entire exterior surface or circumference of the outlets. That is, the threads 23 do not circle the circumference of the outlets. For example, the threaded portion 23 of outlet 20 is provided in an area of less than 50% of the external circumference or surface of the outlet 20. The threaded portion or threads 21 of outlet 22 is provided in an area of the circumference of greater than 50% but less than 100% of the surface area of the outlet 22. When interengaged as shown in FIG. 2, a substantially cylindrical container assembly outlet is formed having a substantially continuous thread provided thereon. Closure 18 is in the form of a cap having an internal thread which can be screwed onto threads 21 and 23 of the container assembly outlet to secure outlets 20 and 22 together. A tamper evident band 16 may be joined to closure 18, which may be separated from closure 18 when closure 18 is removed from the container outlet (see FIG. 2).

When containers 12 and 14 are interengaged ribs 32 and 33 interengage with recesses 37 and 36 to relatively retain containers 12 and 14 in their desired positions, that is, interengaging member prevent the containers 12 and 14 from splaying out of alignment.

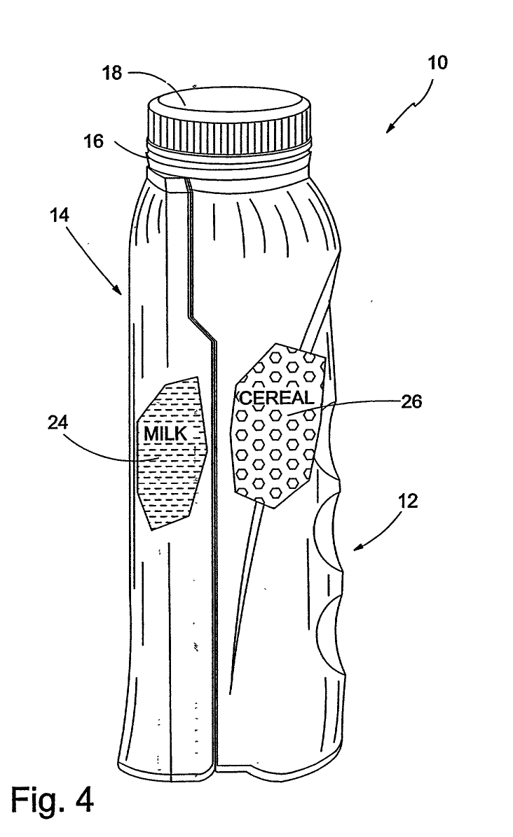

As shown in FIG. 4 the contents of the container 12 and 14 are shown in a cut away, a liquid or other flowable material 24, such as milk, water, syrup or yoghurt, is provided in container 14 and particulate, powdered or granular material such as snacks, puffed foods, cereal or flakes is provided in container 12.

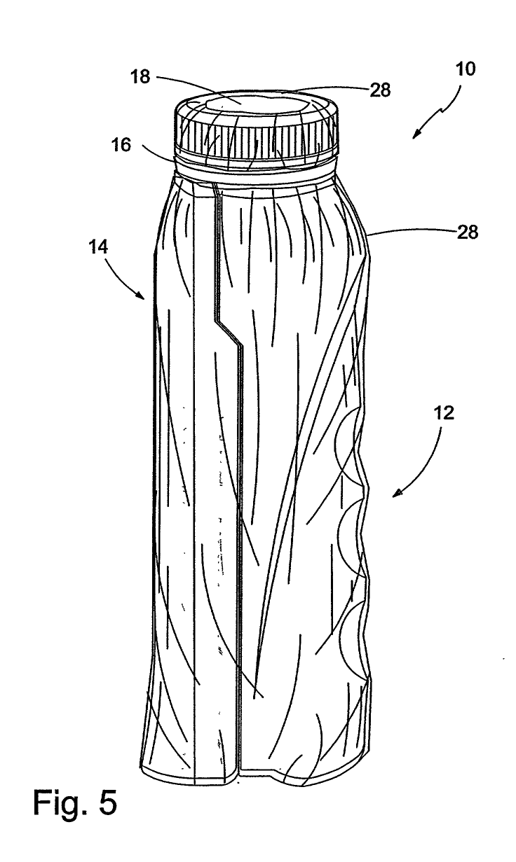

In one embodiment a label (not shown) may extend over containers 12 and 14 and be secured to both containers to retain containers 12 and 14 together and provide additional integrity to elements 32, 33, 36 and 37. A label may extend over both joints between containers to securely retain the containers and prevent splaying. Alternatively, or additionally, as shown in FIG. 5, a heat shrinkable film, such as polyethylene terephthlate (PET) film 28 may be applied over substantially the entire container to retain the containers together and to retain closure 18 in place. A perforation may be provided in heat shrinkable form 28 about the neck of the container assembly to enable easy removal of closure 18 A further perforation may be provided in the longitudinal direction to enable removal of the wrapper and separation of the containers from one another. Enlarged flanged feet sections 17 and 19 provide stability for the container assembly.

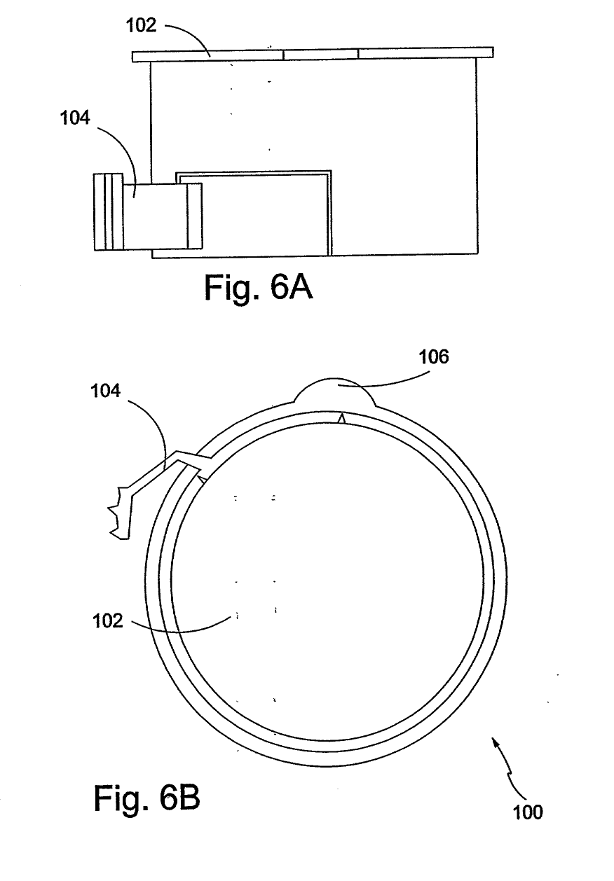

FIGS. 6A and 6B show an alternative closure 100, which may be substituted for closure 18 shown in the previous drawings. Closure 100 includes a top 102 having a tab 106 projecting therefrom and a tear away band 104 for facilitating the removal of the cap. This closure has the advantage that a tamper evident feature may be incorporated within the closure without requiring an additional tamper evident element.

Containers 12 and 14 are preferably filled with different consumable products. Container 12 may be filled with a granular or particulate food product 26 such as a cereal. Container 14 may be filled with a flowable or liquid food product such as milk, syrup or yoghurt. Container 12 may be filled with a first food product at a first location whilst container 14 is filled with a different food product at another location. After container 12 is filled outlet 22 may be sealed by a seal 38 (see FIG. 3B), such as a foil liner. Likewise, outlet 20 of container 14 may be sealed by a seal 34 (see FIG. 3A), such as a foil liner, after filling. This allows the containers to be transported separately. The containers may then be brought together and assembled for distribution at another location. Alternatively both containers may be filled at a common site, in which case a single seal covering both outlets may be applied. A reclosure device in the form of a plug 30 may be provided to seal outlet 20 after opening to avoid spillage of the liquid or flowable component between consumption or if the portion is not consumed.

Gripping formations 15 may be provided in outer wall 35 of container 12 to facilitate gripping and orientation of the container assembly. Outlet 20 is preferably located slightly underneath outlet 22 during consumption to avoid spilling or leakage of fluid into container 12. Outlet 20 is therefore preferably located opposite gripping formations 15. Gripping formations 15 are also preferably provided so as to position the hand of a user near deformable regions 39 and 40 of containers 12 and 14. Exterior walls 11 and 13 of containers 12 and 14 preferably include deformable regions of reduced thickness towards the centers of the containers to facilitate deformation to eject the contents of the containers. Containers 12 and 14 are preferably formed of flexible plastics materials, and the deformable region may be of a thickness ranging from approximately seven eights to two thirds thickness of the side edges where the recesses or ribs are located. The deformable area runs relatively longitudinally of the container.

In use a user may remove closure 18 or 100; remove seals 34 and 38 (or a single seal covering both outlets. If two seals are provided only a single seal needs to be removed if one desires to consume only one of the components of the package); grip the container assembly so that their fingers engage gripping formations 15; lift the container assembly and place outlets 20 and 22 within their mouth (outlet 20 being located below outlet 22); and, if necessary, squeeze deformable regions 39 and 40 to eject the contents of the containers. Plug 30 may be placed with the passageway 27 of outlet 20 to temporarily seal outlet 20 to avoid spilling the liquid contents therein.

The container assembly of the present invention allows the containers to be filled with different food products at different locations prior to assembly and distribution. The container assembly enables different food products to be simultaneously delivered to the user. The container assembly delivers the food products in a manner which allows consumption “on the go’.

It will thus be seen according to the present invention a highly advantageous container assembly has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A container assembly for dispensing consumable products including:
a first generally elongate container being sized and configured and having a first dimension to receive a first consumable product having an outlet at one end thereof;
a second generally elongate container being sized and configured and having a second dimension different from the first dimension to receive a second consumable product having an outlet at one end thereof;
the outlets of each of the first and second containers are configured and dimensioned to nestle together when the containers are positioned adjacent one another to form a container assembly outlet of a size that can be accommodated by a human mouth; and
wherein the first and second containers are placed in a co-operative engagement such that said first and second containers do not splay out of an alignment with one another.

2. A container assembly as claimed in claim 1 including a binding element that holds the first and second containers together.

3. A container assembly as claimed in claim 1 wherein the outlet of the second container has a passageway there through of a smaller cross sectional area than a passageway through the outlet of the first container.

4. A container assembly as claimed in claim 3 wherein the outlet of the first container is positioned near the periphery of the container assembly outlet.

5. A container assembly as claimed in claim 4 wherein the container assembly outlet is substantially circular in cross section.

6. A container assembly as claimed in claim 5 wherein the container assembly outlet is about 38 mm in diameter.

7. A container assembly as claimed in claim 3 wherein the container outlet passageways are dimensioned so as to deliver consumable products at a rate commensurate with the viscosity or density of the first and second consumable products.

8. A container assembly as claimed in claim 1 wherein the first container includes a first side wall section and a second side wall section, the second side wall section having interengaging formations; and the second container includes a first side wall section and a second side wall section, the second side wall section having interengaging formations adapted to interengage with the interengaging formations of the second side wall section of the first container.

9. A container assembly as claimed in claim 8 wherein the interengaging formations consist of one or more male formations on one container and one or more complementary female formations on the other container.

10. A container assembly as claimed in claim 9 wherein one or more protruberance extends from one container adapted for engagement with one or more complementary recess in the other container.

11. A container assembly as claimed in claim 1 wherein the first container includes one or more deformable region.

12. A container assembly as claimed in claim 11 wherein the deformable region is a central region of the first side wall section having a thinner side wall section than the surrounding regions.

13. A container assembly as claimed in claim 8 wherein the first side wall section includes gripping formations.

14. A container assembly as claimed in claim 8 wherein the gripping formations are positioned so as to orient the outlet of the second container towards the bottom of the container assembly outlet during consumption of the consumable products.

15. A container assembly as claimed in claim 8 wherein the first side wall sections of the first and second containers from a substantially continuous outer wall when the first and second containers are interengaged.

16. A container assembly as claimed in claim 1 wherein the first container contains a granular food product.

17. A container assembly as claimed in claim 1 wherein the first container contains a first consumable product and the second container contains a second consumable product, different to the first consumable product.

18. A container assembly as claimed in claim 17 wherein the second container contains a liquid food product.

19. A container assembly, comprising at least first and second containers wherein:
said first container has an exterior wall, a top and bottom, a first and second end edge and first and second side edges and a length and a width, and said first container has at least one longitudinally extending recess in said exterior wall, said first container making up a first volume of the container assembly;
said second container has an exterior wall, a first and second end edge and first and second side edges, and a length and a width and said second container has at least one longitudinally extending protuberance in said exterior wall, said second container making up a second volume of the container assembly;
each of said first and second containers has an outlet in one of said first and second end edges; said outlets of said first and second containers are in co-operative association with one another; and said outlets have passageways therethrough of different dimensions; and
the volume of said first container is greater than the volume of said second container.

20. A container assembly as claimed in claim 19 wherein the at least one longitudinally extending protruberance is engaged with the at least one longitudinally extending recess to restrict relative movement between the containers.

21. A container assembly as claimed in claim 19 wherein exterior wall of the first container includes a first side wall section and second side wall section having the at least one longitudinally extending recess provided therein; and the exterior wall of the second container includes a first side wall section and second side wall section having the at least one longitudinally extending protruberance provided therein.

22. A container assembly as claimed in claim 21 wherein the at least one longitudinally extending protruberance is in the form of a pair of spaced apart ribs extending along sides of the second wall of one container and the at least one longitudinally extending recess is in the form of a pair of spaced apart grooves extending along the edges of the second side wall of the other container.

23. A container assembly as claimed in claim 19 including interengaging formations for securing the first and second containers together.

24. A container assembly as claimed in claim 21 wherein the first side wall section of the first container includes gripping formations to assist with orientation of the container assembly in use.

25. A container assembly as claimed in claim 19 including a binding element securing the first and second containers together.

26. A container assembly as claimed in claim 19 including a closure retaining the outlets of the first and second containers together.

27. A container assembly as claimed in claim 19 wherein the container outlets are sized and dimensioned so that when the containers are interengaged the outlets can be accommodated by the mouth of the user.

28. A container assembly as claimed in claim 27 wherein the outlet of the second container has a passageway of smaller cross sectional area than the outlet of the first container.

29. A container assembly as claimed in claim 28 wherein the diameters of the passageways through the outlets of the containers are dimensioned so as to deliver consumable products contained therein at a rate commensurate with the viscosity or density of the first and second consumable products contained in each container.

30. A container assembly for dispensing consumable products, said container assembly including;
a first container being sized and configured to receive a first consumable product, said first container having a longitudinal axis and a transverse axis and having a first volume ; and
a second container being sized and configured to receive a second consumable product, said second container having a longitudinal axis and a transverse axis and having a second volume, different than said first volume;
wherein each of said first and second containers has an outlet, with said outlets of said first and second containers nestling together; and
at least one of said first and second containers has a deformable region, which is deformable upon the application of pressure in a direction which is perpendicular to said longitudinal axis of each of the or each container.

31. A container assembly as claimed in claim 30 including a binding element that holds the first and second containers together.

32. A container assembly as claimed in claim 30 wherein the outlet of the second container has a passageway there through of a smaller cross sectional area than a passageway through the first container.

33. A container assembly as claimed in claim 32 wherein the outlet of the first container is positioned to one side of the outlet of the second container.

34. A container assembly as claimed in claim 33 wherein the outlets form a substantially cylindrical container assembly outlet.

35. A container assembly as claimed in claim 34 wherein the container assembly outlet is about 38 mm in diameter.

36. A container assembly as claimed in claim 32 wherein the container outlet passageways are dimensioned so as to deliver consumable products at a rate commensurate with the viscosity or density of the first and second consumable products.

37. A container assembly as claimed in claim 30 wherein the first container includes a first side wall section and a second side wall section, the second side wall section having interengaging formations; and the second container includes a first side wall section and a second side wall section, the second side wall section having interengaging formations adapted to interengage with the interengaging formations of the second side wall section of the first container.

38. A container assembly as claimed in claim 37 wherein the interengaging formations consist of one or more male formations on one container and one or more complementary female formations on the other container.

39. A container assembly as claimed in claim 38 wherein one or more protruberance extends from one container adapted for engagement with one or more complementary recess in the other container.

40. A container assembly as claimed in claim 30 including interlocking formations which secure the first and second containers together.

41. A container assembly as claimed in claim 37 wherein the first container has a larger volume than the second container.

42. A container assembly as claimed in claim 30 wherein the first container contains a first consumable product and the second container contains a second consumable product, different to the first consumable product.
